(19) United States
(12) Patent Application Publication
(10) Pub. No.: US 2014/0177292 A1
(43) Pub. Date: Jun. 26, 2014

(54) MULTILEVEL VALVE FOR VOLTAGE SOURCED CONVERTER TRANSMISSION

(71) Applicant: Dennis A. Woodford, Winnipeg (CA)

(72) Inventor: Dennis A. Woodford, Winnipeg (CA)

(21) Appl. No.: 13/777,886

(22) Filed: Feb. 26, 2013

Related U.S. Application Data
(60) Provisional application No. 61/745,546, filed on Dec. 21, 2012.

(51) Int. Cl. H02J 3/36

(52) U.S. Cl. CPC H02J 3/36
USPC 363/35

(57) ABSTRACT

A method for transforming electric power from high voltage AC voltage and AC current to high voltage DC voltage and DC current and from high voltage DC voltage and DC current to high voltage AC voltage and AC current. The method includes passing the power through voltage sourced converters whose legs are comprised all or in part with 3 step ladder bridge modules connected in series.

### FIELD OF THE INVENTION The invention pertains to conversion of electric power from DC voltage to AC voltage with voltage sourced converters (VSC). AC DC AC DC DC

### BACKGROUND OF THE INVENTION

Electric power is often transformed from high voltage (hundreds of kilovolts) AC to high voltage (tens to hundreds of kilovolts) DC to transfer power through a short interconnection or through a single transmission line or cable system and transformed back from DC to ac. This is done in order to achieve more efficient long distance transmission of electric power or to achieve other network-related operational advantages. New projects are being developed with a multiplicity of VSC converters in a DC grid system.

Prior art with respect to dc-to-ac and AC to DC transformation at high transmission voltage levels is developing with multilevel converters. One example of a recent configuration is US Patent Application publication 2012/0218795 which cites a method that uses a 3-level flying capacitor leg coupled in parallel with one or more half-bridge modules in a 2-level leg.

The prior art for the application of multilevel converters as evident in the patent applications cited apply the basic voltage sourced converter modules of half bridge and full bridge in various arrangements. The full bridge converter module is sometimes referred to as a chain link module (US Patent Application publication 2012/0188803 and US Patent Application publication 2012/0170338). The modules may also consist of a variety of configurations of voltage sourced converters assembled into conventional bridge formation with electronic switches such as in 2 level, 3 level neutral point clamped converter, multilevel neutral point clamped converter, three level floating capacitor and multi-level floating capacitor.

Each multilevel module for each configuration will consist of an energy storage device such as a capacitor, or even a battery. The one or more electronic switches in each module may consist of insulated gate bipolar transistors (IGBTs), thyristors, gate turn-off thyristors, field-effect transistor and reverse conducting diodes.

US Patent Application publication 2012/0113699 shows one configuration of a voltage sourced converter that has each leg of the converter consisting of a series connection of one or more full bridge modules with variations that may include in series with the full bridge modules either one or more single IGBT modules each with its reverse biased diode or one or more half bridge modules. Each pair of legs connected at one end to the positive DC voltage polarity in one instance and to the negative DC voltage polarity in the other instance and connected together in series to form a mid-point connection between the positive and negative DC voltage polarities which may be connected to one AC phase through an inductor from that mid-point in the pair of series connected legs. Such a connection may be expanded to each AC phase and the DC positive and negative voltage polarities to form the voltage sourced converter.

Marquardt R., Lesnicar A. “New Concept for High Voltage—Modular Multilevel Converter”, PESC 2004 Conference Aachen, Germany proposes a modular multilevel converter (MMC) by using a switching device capable of ON/OFF control. The MMC configuration has recently become standard practice for voltage sourced converter transmission and variations of MMC with or without pulse width modulation (PWM) are applied in the patent applications cited herein.

A. Balikci, E. Akpinar, “A Three-Phase Four-Wire Statcom With Reduced Number of Switches for Unbalanced Loads”, Paper A4.1, ACDC 2012 Conference of the Institution of Engineering and Technology, 4-6 Dec. 2012, Birmingham, U.K. presents a new configuration of an electronic switch applied to a STATCOM. This new configuration of a 3 step ladder bridge has a similar function to two series connected full bridge modules.

There are various configurations of modules and voltage sourced converters which are representative in recent patent applications and prior art documents.

### SUMMARY OF THE INVENTION

The invention disclosed herein provides a new means to configure a leg of a VSC that achieves operational advantages such as limiting DC fault current when a fault to ground or a pole to pole fault occurs in the DC system. Such a protection and control action may quicken the recovery of the DC system if transmission capability remains on the DC system after the DC fault is cleared. This ability to limit DC fault current is not unique to this invention as it is achievable with full bridge modules in each leg of the VSCs. The full bridge module is also known as an H bridge or a chain link bridge. The new configuration of the 3 step ladder bridge module can achieve the same performance as the H bridge module but with fewer losses and less overall solid state components. The application of the 3 step ladder bridge module for VSC transmission is a unique feature of this invention.

In accordance with the principles of the invention, in some embodiments, a method for transmitting electric power over a high voltage power grid between high voltage AC and DC network elements can be provided. The method can include implementing a voltage sourced converter comprising a plurality of series-connected modules in each limb of the voltage sourced converter, wherein the voltage sourced converter converts high voltage DC to AC by operating the series-connected modules with each module being configured to convert a DC voltage through use of a three step DC voltage ladder module. The method including selectively controlling a switching operation of six subportions in each module by which the module is placed in one of three available operational states. In response to the switching, in a first state, directing current in series from a first subportion to a first capacitor, wherein the voltage across the capacitor establishes a first voltage level across the module, in a second state, directing current from a first subportion through the first capacitor, a second subportion, a second capacitor, and third subportion, wherein the voltage across the first and second capacitors establishes a second voltage level across the module, and in a third state, directing current from the first subportion through a fourth subportion and third subportion without involving the first and second capacitors, which establishes a third voltage level across the module.

The method can include implementing no more than six insulated gate bipolar transistors each with accompanying reverse biased diodes in each module in each module. The method can include implementing three limbs each comprising two arms in series whereby generating electrical power signals compatible with conventional power systems is provided, where the power systems may be single phase or three-phase. The method can be implemented such that each module has an operation performance that is substantially the same as two full bridge modules connected in series but fewer switching losses because of less solid state components. One or more limbs includes a series inductor connected in the limb if desired.

In some embodiments, a method for delivering high voltage alternating current power as part of an electrical power distribution network is provided. The method comprising implementing a plurality of series connected modules, wherein each module converts a high voltage DC signal through use of a three step ladder module across a first and second terminal of the module in response to selectively applied control signals that control six high power semiconductor switching elements in each module. In each of the series connected modules, the method can be implemented by applying the control signals over time to establish at least one of the following three states: a first state wherein direct current flows through three high power semiconductor switching elements and two capacitors in response to which a first voltage level is established across the terminals of the module, a second state wherein direct current flows through two high power semiconductor switching elements, a capacitor, and a reverse biased diode in response to which a second voltage level is established across the terminals of the module, and third state wherein direct current flows through two high power semiconductor switching elements and a reverse biased diode and in response to which the third voltage level is established across the terminals of the module.

The high power semiconductor switching elements are, for example, insulated bipolar gate transistors, each of which also may be accompanied by one or more reverse biased diodes. The method can implement circuitry in which the first voltage level is twice the second voltage level. The method can include implementing in the network a voltage sourced converter that uses the modules to convert DC to AC. In some embodiments, the module consists essentially of six insulated gate bipolar transistor, six reverse biased diodes, and two capacitors.

In some embodiments, a voltage sourced converter that converts high voltage DC to high voltage AC in an electrical power distribution grid can be provided. The voltage sourced converter can include a module that converts high voltage DC through use of a three step high voltage ladder module, wherein the module comprises a first and second terminal; three pairs of insulated high power insulated bipolar gate transistors, wherein the pairs are connected in series and the middle pair is positioned at a reverse polarity in relation to its series connected high power insulated bipolar gate transistors; six reverse bias diodes, each diode connected in parallel across one of the insulated bipolar gate transistors; two capacitors that are connected in parallel, wherein a first capacitor is connected between the first and second pairs of high power insulated bipolar gate transistors and a second capacitor is connected between the second and third pairs of high power insulated bipolar gate transistors.

The voltage sourced converter is configured to have each capacitor a first terminal connected in between two of the high power semiconductor insulated bipolar gate transistors and a second terminal connected in between another two of the high power semiconductor insulated bipolar gate transistors if desired.

Each high power insulated bipolar gate transistor of the voltage sourced converter embodiments can be configured to receive a control signal that determines a voltage state of the module.

The voltage sourced converter preferably has at least one limb with two legs and each limb comprises a set of series connected modules which in operation convert DC to AC. It is usual to have three limbs with two legs in series per limb for conversion between three phase AC and DC. In some embodiments, the converter can comprise one, two or three limbs with each limb comprising two legs in series, and each limb or leg comprises a set of series connected modules which in operation convert DC to AC.

The voltage sourced converter of wherein each leg in a limb comprises at least one module.

In some embodiments, A high voltage power distribution grid can be provided comprising a plurality of voltage sourced converters that distribute high voltage DC or high voltage AC to AC or DC components of the network, wherein one or more of the voltage sourced converters comprises means for converting a high voltage DC through use of a three step voltage ladder module.

In at least some embodiments, a method for transforming electric power from from high voltage DC voltage and DC current to high voltage AC voltage and AC current which comprises passing the power through voltage sourced converters (VSCs) whose legs are comprised all or in part with 3 step ladder bridge modules connected in series. If desired, the method can include providing each leg of a VSC as a series of modules, which may include one or more 3 step ladder bridge modules. The method can further comprise providing each leg of a VSC as a series connection of modules, which may include one or more modules of other types of electronic switches along with the series connection of one or more 3 step ladder bridge modules. The method can further comprise providing each leg of a VSC with one or more 3 step ladder bridge modules that have a series inductor connected into the leg. The method can further include providing a VSC with one or more 3 step ladder bridge modules in each leg that can be controlled with multilevel operation with or without pulse width modulation. The method can be implemented wherein operation of a single 3 step ladder bridge may have the same operational performance as two full bridge modules connected in series. A VSC containing 3 step ladder bridge modules in each leg may operate similarly to a VSC containing full converter bridge modules in each leg that are equivalent in voltage and current rating and are similarly controlled. The 3 step ladder bridge modules can have fewer switching losses than the full converter bridge modules that are equivalent in voltage and current rating and are similarly controlled.

### BRIEF DESCRIPTION OF THE DRAWINGS

Other features and advantages will occur to those skilled in the art from the following description of the preferred embodiment of the invention and the accompanying drawings.

FIG. 1 shows how one and each leg of a VSC may consist of 3 step ladder bridge modules connected in series along with supplementary modules that may be series connected into the leg.

FIG. 2a shows how one or more supplementary modules connected in series in a VSC leg with 3 step ladder bridge modules may just be a simple connection.

FIG. 2b shows how one or more supplementary modules connected in series in a VSC leg with 3 step ladder bridge modules may just be an inductor.

FIG. 2c shows how one or more supplementary modules connected in series in a VSC leg with 3 step ladder bridge modules may be half bridge modules connected in series with or without an inductor

FIG. 2d shows how one or more supplementary modules connected in series in a VSC leg with 3 step ladder bridge modules may be electronic switches in series with or without an inductor.

FIG. 3 is circuit diagram of an illustrative module in accordance with one embodiment of the present invention.

FIG. 4 is a circuit diagram illustrating an operation state of the module in accordance with one embodiment of the present invention.

FIG. 5 is a circuit diagram illustrating an operation state of the module in accordance with one embodiment of the present invention.

FIG. 6 is a circuit diagram illustrating an operation state of the module in accordance with one embodiment of the present invention.

FIG. 7 is a table illustrating switching logic for devices in the module in accordance with one embodiment of the present invention.

FIG. 8 is circuit diagram illustrating a convention full bridge converter in voltage sourced converters,

FIG. 9 is a circuit diagram of an illustrative high power distribution network in which the module is used to implement voltage sourced converters in accordance with one embodiment of the present invention.

FIG. 10 is a circuit diagram that illustrates a three limb design for a three phase power system.

### DETAILED DESCRIPTION OF THE INVENTION

The method pertains to just a single leg of a voltage sourced converter with capability of applying multilevel modular converter (MMC) technology with or without pulse width modulation (PWM). Multiple legs are required for a voltage sourced converter which is assembled either for single phase AC to DC VSC conversion or three phase AC to DC VSC conversion. Each leg in a VSC converter consists of one or more series modules. Some modules connected in series in a leg may differ from other modules as there is a multiplicity of configurations that may be applied. The novel and unobvious feature of this invention is that one or more modules designated herein as a “3 step ladder bridge” are connected in series in a leg of a VSC for DC transmission and so replicated in all legs of the VSC for application as an MMC with or without PWM. The minimum modules in a leg can be one, but the maximum number is not specifically set and could be as many as several hundred or more in accordance with existing practice.

The configurations described herein and their proposed methods of implementation are based on commonly understood electrical principles and components associated with VSCs. The application of those configurations and methods to the invention would be achieved by various power electronic devices, e.g. IGBTs, transistors, gate turn-off thyristors or field-effect transistors and reverse biased diodes, all of which are well understood in structure and operation. They represent a broad field of prior art.

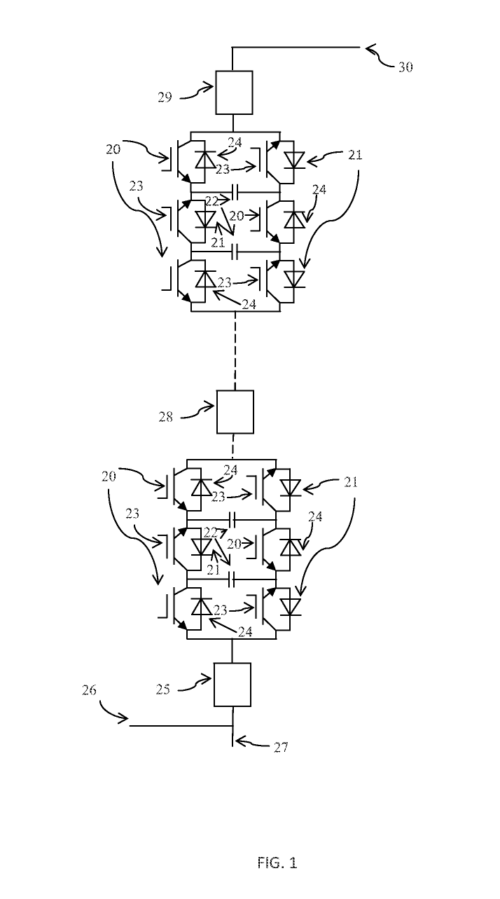

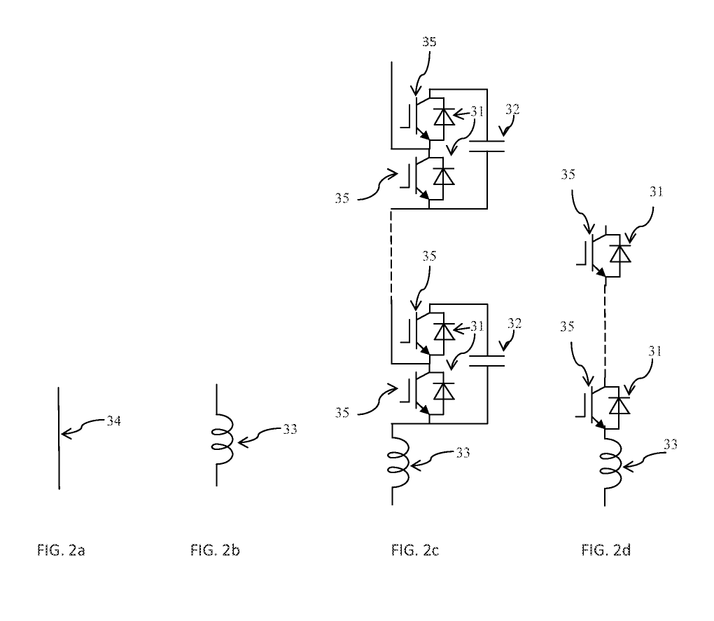

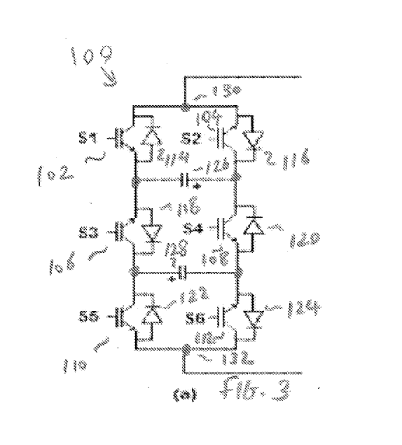

FIG. 1 shows one positive DC potential leg of a VSC with 3 step ladder bridge modules having individual components 20 through to 24. Blocks 25, 28 and 29 may represent some additional types of components or modules depicted in FIGS. 2a, 2b, 2c and 2d. The connection to one phase of AC voltage is 26. The positive potential end of the negative DC potential leg similar or identical to the positive DC potential leg is 27. The positive potential end of the positive DC potential leg is 30.

The components or modules that may be included in blocks 25, 28 and 29 of FIG. 1 depicted in FIGS. 2a, 2b, 2c, 2d. FIG. 2a represents a connection with no component or module as 34. FIG. 2b shows an inductor 33. FIG. 2c shows a series connection of one or more well-known half bridge modules in series with an inductor 33. The half bridge modules typically consist of two IGBTs 35, 2 reverse biased diodes 31 and capacitor 32 and with or without a series inductor 33. FIG. 2d shows a series connection of one or more electronic switches with IGBTs 35 and reverse biased diodes 31, and with or without a series inductor 33.

The components or modules included in blocks 25, 28 and 29 in series with the 3 step ladder modules of FIG. 1 may be different in each block.

The components of each step in the 3 step ladder modules of FIG. 1 consist of IGBTs, gate turn-off thyristors or field-effect transistors 20 and 23, reverse biased diodes 21 and 24 and capacitors 22.

The polarity of electronic components in the center section of the 3 step ladder module is reverse biased to the electronic components in the end sections. This enables the current through the electronic components and capacitors to be controlled so that essentially the performance is similar to that of two fill converter bridges connected in series. In other words, the current may pass in either direction through the 3 step ladder module under the control of separate electronic or digital controls and through its three levels to operate at either zero voltage across any particular module, or to operate at half the module's designed DC voltage or to operate at the module's designed DC voltage.

A further operational characteristic of the 3 step ladder module with suitable controls is to operate with bidirectional current through its three levels to at either zero voltage across any particular module, or to operate at half the module's designed DC voltage in reverse polarity or to operate at the module's designed DC voltage also at reverse polarity.

With reference now to FIG. 3, module 100 comprising a three step voltage ladder bridge of FIG. 1 is illustrated. Module 100 includes insulated bipolar gate transistors (“IGBT”) S1 102, S2 104, S3 106, S4 108, S5 110, and S6 112. Module 100 also includes reverse bias diodes (positioned across each IGBT) 114, 116, 118, 120, 122, and 124. Module 100, as shown, also includes two capacitors 126 and 128. Module 100 also includes terminals 130 and 132. Module 100 is configured to apply control signals to IGBTs S1 102, S2 104, S3 106, S4 108, S5 110, and S6 112 so as to place module 100 in one of three specific states. In addition, polarity of the voltage and its application to module 100 can be controlled to be able have each of the three states have two operational states, a positive and negative operational state, with possibly the exception of operation at a zero voltage state level being common to both groups of states.

Module 100 is circuitry that is arranged in a particular fashion. The circuitry is arranged between terminal 130 and 132. The voltage across terminals 130 and 132 is generated as a result of the operation of the circuitry between terminals 130 and 132. Module 100 has three pairs of series connected IGBTs with the first and third pairs having the same arrangement of polarity and the middle pair having IGBTs 106, 108 positioned at a reverse polarity in comparison to the first 102, 104 or third 110, 112 IGBT pairs. Capacitor 126 is connected in between the first 102, 104 and second pair 106, 108 of IGBTs and capacitor 128 is connected in between the second 106, 108 and third pair 110, 112 of IGBTs as shown. Capacitor 126 is arranged to connect a terminal that is also connected to a pole of IGBT 104 and IGBT 108 to a terminal that is also connected to a pole of IGBT 102 and IGBT 106, Capacitor 128 is arranged to connect a terminal that is also connected to a pole of IGBT 108 and IGBT 112 to a terminal that is also connected to a pole of IGBT 106 and IGBT 110, Capacitors 126 and 128 are connected in the circuitry in parallel. Capacitors 126 and 128 establish a cross connect path that can be activated depending the switching state of the IGBTs to include or exclude one or more of capacitors 126 and 128 in the current path. The switching can also place IGBTs that have the same polarity in a series connected arrangement. Reverse bias diodes 114, 116, 118, 120, 122, and 124 are each paired with one of IGBTs 102, 104, 106, 108, 110, and 112 and are each positioned across the positive and negative terminals of its associated IGBT. Reverse bias diodes can each be activated depending on the voltage across the diode to allow current to pass through the diode without involving its associated IGBT.

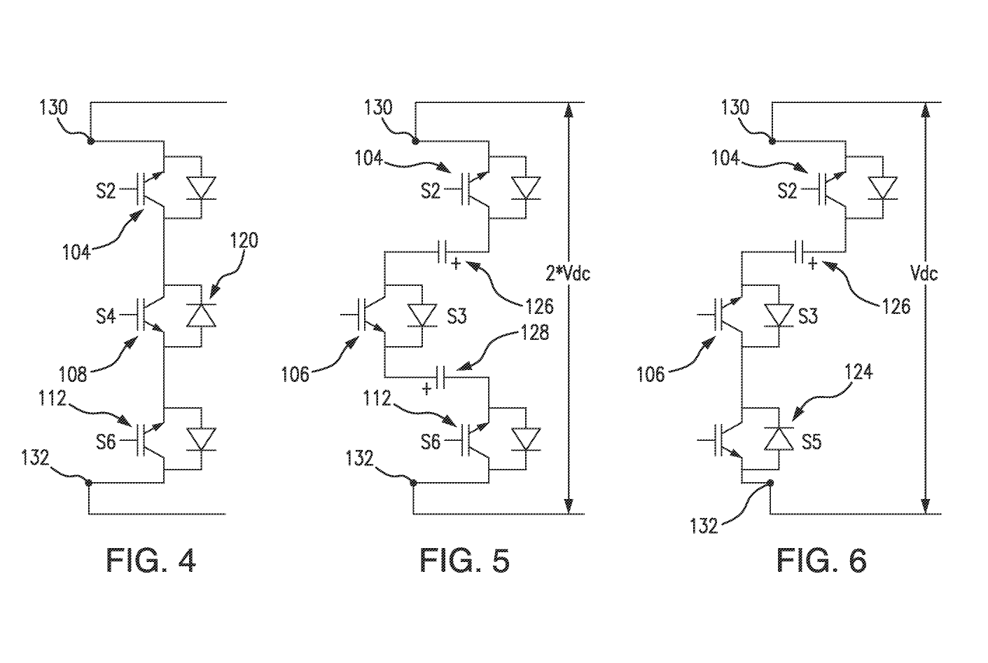

In operation, different elements can be selectively included or excluded from the current path in order to establish different operational states and related voltage With reference now to FIGS. 4-6, operation of module 100 is illustrated in converting DC voltage to one of three step voltage ladder levels. In FIG. 4, a short circuit or a zero voltage across terminal 130 and 132 is established in response to control settings applied to the IGBTs in accordance with the logic table provided in FIG. 7. In operation, current flows through terminal 312 to IGBT S6 112. Diode 120 is biased to allow current to pass through the diode without involving IGBT S4 108, Current from IGBT S6 112 would pass through diode 120. Current from diode 120 reaches IGBT S2 104, which has been switched “on” based on its logic control setting. Current would then flow through terminal 130. A voltage state established in response to the operation of the circuitry and involved module components results in a voltage level across terminals 130 and 132. In this state, there are no significant voltage generating elements in the current path which in response establishes a zero voltage level across terminals 130 and 132. In this state, other IGBT are configured to establish an open circuit across the other rail of the module.

With reference to FIG. 5, two capacitors can be triggered to be in the current path, which in response established a different voltage level across terminals 130 and 132. In operation, IGBTs S2 104, S3 106, and S6 112 are selectively controlled to be switched “on,” Other IGBTs and paired diodes are controlled to implement an open circuit. The configuration in operation connects IGBT S2 104, capacitor 126, IGBT S3 106, capacitor 128, and IGBT S6 112 in series. As shown, the circuit components are connected in the illustrated sequence. Current flows through each of the series connected elements from IGBT S6 112 through the other series connected elements in this state and ultimately through terminal 130. Capacitors 128 and 126 can charge during operation through judicious control common as a prior art to half bridge and full bridge modules so to operate similarly to individual batteries. In response to the control operation and arrangement of circuitry, IGBT S2 104, capacitor 126, IGBT S3 106, capacitor 128, and IGBT S6 112 establish a voltage across those network elements which is the voltage across terminals 130 and 132 or representative thereof. In operation, incorporating two capacitors having the same operational characteristics in the current path establishes a voltage level that is twice the voltage level of each capacitor.

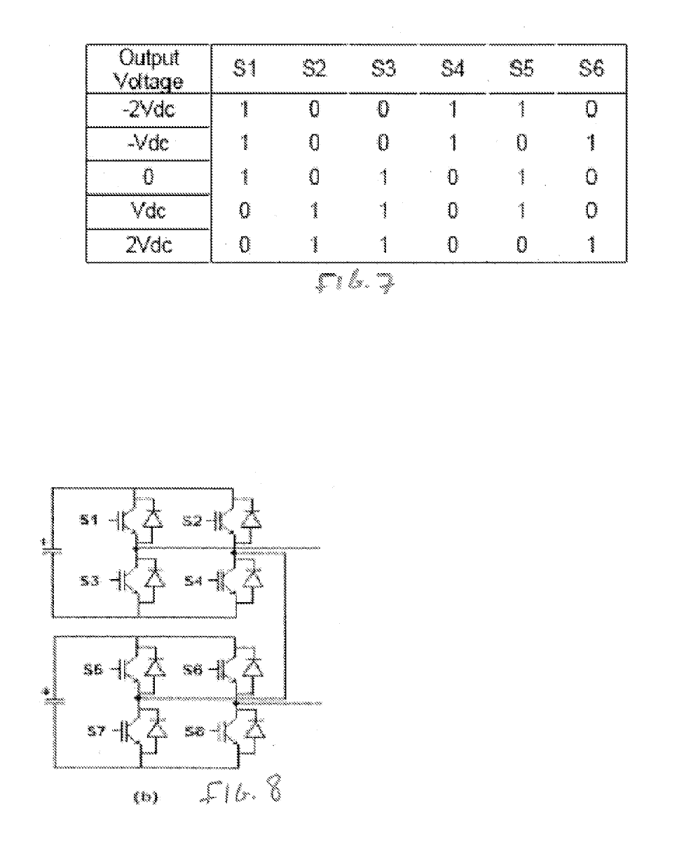

With reference to FIG. 6, one of the two capacitors can be triggered to be in the current path which in response establishes a different voltage level, a third voltage level, across terminals 130 and 132. In operation, diode 124, IGBT S3 106, capacitor 126, and IGBT S2 104 are selectively controlled to be switched “on.” Other IGBTs and paired diodes, each IGBT and diode pair being a subportion of module 100, are controlled to implement an open circuit. The configuration, in operation, connects diode 124, IGBT S3 106, capacitor 126, and IGBT S2 104 in series. As shown, the circuit components are connected in the illustrated sequence. Current flows through each of the series connected elements from diode 124 through the other series connected elements in this state and ultimately through terminal 130. Capacitor 126 can charge during operation so at to operate similarly to an individual battery in a DC circuit. In response to the control operation and arrangement of circuitry, diode 124, IGBT S3 106, capacitor 126, and IGBT S2 104 establish a voltage across those network element which is the voltage across terminals 130 and 132 or representative thereof. In operation, incorporating capacitor 126 without incorporating capacitor 128 establishes a voltage that is half the voltage level of the ladder voltage state of FIG. 5. As in the other states, control logic setting from FIG. 7 are used to configure a desired state. The elements can be controlled to direct current in the reverse direction across different paths through IGBTs, diodes, and/or capacitors to establish voltage levels of the three step ladder in an opposite polarity in accordance with the control settings of FIG. 7. Control signals can be applied over time to sequence so as to generate a ladder based sinusoidal wave using multiple modules in way that the voltage curve will rise and fall based on the number of modules and the state of modules activated in the leg or limb of a converter.

By implementing module 100 in series and controlling its elements with appropriate timing, the operation of multiple modules can cumulatively generate a DC to AC wave shape at least because of the culmination of many the three step ladders converters can generate a sinusoidal wave. Increasing the number of modules used can improve the smoothness of the curve. Module 100 can be used in each module of the converter or other bridges or components can be combined if desired. In general, operation with module 100 for all of the converter elements is preferred. A voltage sourced converter in high voltage power distribution network can be implemented to use module 100 in each limb or leg of its structure such as the limb illustratively shown in FIG. 1. Three limbs or legs can be implemented in each voltage converter in order to implement electrical operation compatible with conventional AC power delivery networks. Other circuitry, circuit components, or bridges can be used in combination with module 100 such as those illustratively provided as examples in FIGS. 2a-2d.

The six IGBTs (or similar high power semiconductor switches), reverse bias diodes (or circuitry that provides substantially the same functionality and characteristics, and capacitors (or capacitor elements) and interconnecting circuit as generally illustrated herein can form a module for three step ladder conversion that consists essentially of those elements in that arrangement in at least some embodiments. As compared to a conventional implementation of a bridge using full bridge modules as for example show in FIG. 8, module 100 includes fewer components (six IGBTs, six diodes, two capacitors versus 8 IGBTs, 8 diodes, and two capacitors) while providing substantially the same operational capability with less voltage leakage and implementations costs (e.g., due to fewer elements). It is contemplated that a greater numbers of elements or other types of circuit elements can be included (e.g., replacing a single IGBT with two IGBTs) without departing from the scope and concept of the inventions contemplated herein.

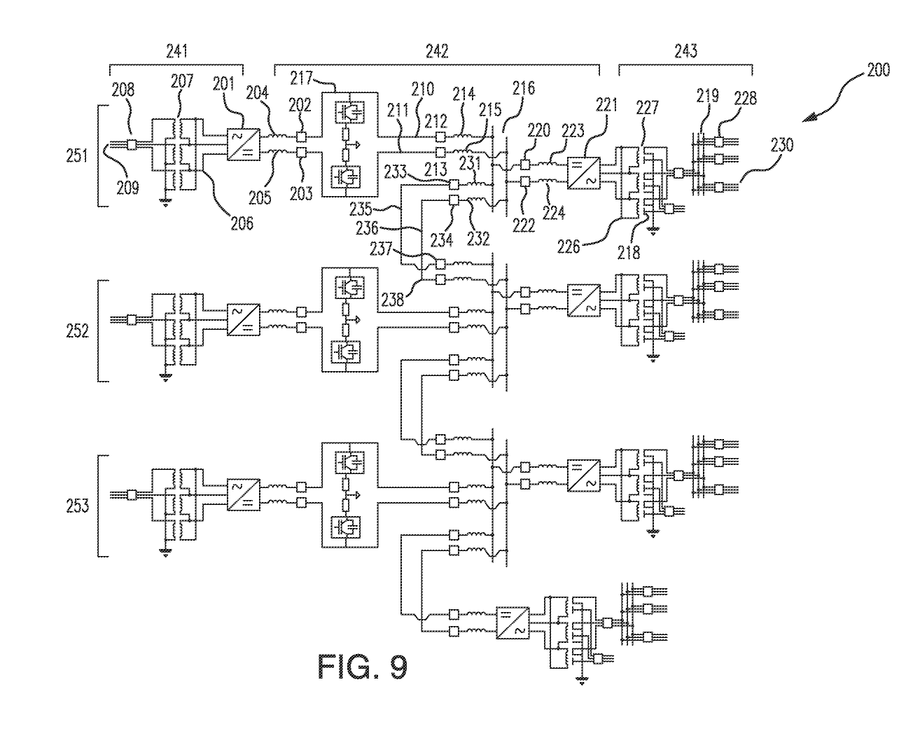

With reference now to FIG. 9, DC power grid or network 200 is illustrated that delivers power to network components including the conversion of AC and DC voltage as part of the network operation. Operation of network 200 is illustratively described in U.S. patent application Ser. No. 13/715,520, filed Dec. 14, 2012, which is hereby incorporated herein in its entirety by reference thereto. If desired, grid 200 can be implemented with or without a central controller. At least one, some, or all of voltage sourced converters in grid 200, such as voltage sourced converter 201 and 221, is configured to include module 100 in one, some, or all of its three step ladder converters in each limb or leg of its three phase DC to AC converter arrangement,

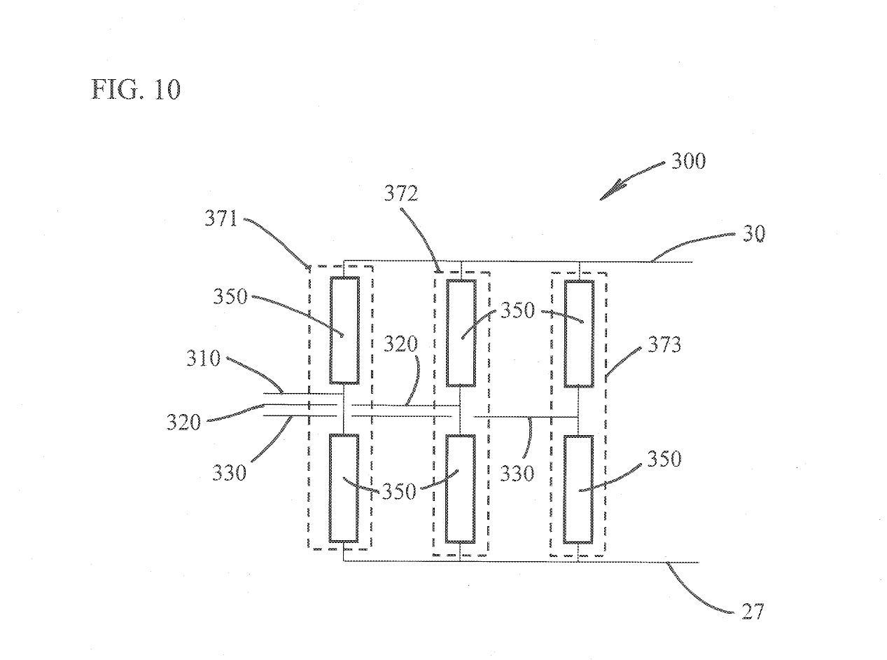

With reference to FIG. 10, a DC to three-phase AC converter 300 is illustrated having six legs 350 arranged in 3 limbs 371, 372, 373, where each leg may comprise one or more modules 100 (as shown in FIG. 3) connected together in series along with other components (as shown in FIGS. 2a-d). Connections to positive and negative DC inputs 27, 30 may be made to one end of each leg 350, and three connections can be made to the three-phase AC current outputs 310, 320, 330, where 310 is a conductor carrying a first phase Φ₁ produced by a first limb 371, 320 is a second phase Φ₂ produced by the second limb 372, and 330 is a conductor carrying a third phase Φ₃ produced by the third limb 373. Increasing the number of modules used in each leg 350 can improve the smoothness of the AC curve for each phase.

Voltage levels and operations do not need to be exact as specific because it would be understood to those of ordinary skill in the art that the number or specified operation include reasonable approximate variations in performance which maintains substantially the same operational voltages or performance.

While description of individual embodiments in preceding paragraphs may be illustrated by means of a particular voltage reversal or voltage reduction principles, the methods inherent in those embodiments and the systems developed for implementation of those methods should be construed as embracing prior art because these operational performances can be achieved with full bridge modules. A unique benefit of the 3 step ladder bridge module is that in achieving the same performance as the H bridge module, it does so with fewer losses because fewer solid state switches are implemented.

What is claimed is:

1. A method for transmitting electric power over a high voltage power grid between
high voltage AC and DC network elements, comprising:
implementing a voltage sourced converter comprising a plurality of series-connected modules in each leg of the voltage sourced converter, the voltage sourced converter converts high voltage DC to AC by operating the series-connected modules with each module being configured to convert a DC voltage to a three step DC voltage ladder;
selectively controlling a switching operation of six subportions in each module by which the module is placed in one of three available operational states;
in response to the switching, in a first state, directing current in series from a first subportion to a first capacitor, wherein the voltage across the capacitor establishes a first voltage level across the module, in a second state, directing current from a first subportion through the first capacitor, a second subportion, a second capacitor, and third subportion, wherein the voltage across the first and second capacitors establishes a second voltage level across the module, and in a third state, directing current from the first subportion through a fourth subportion and third subportion without involving the first and second capacitors, which establishes a third voltage level across the module.

2. The method of claim 1 comprising implementing no more than six insulated gate bipolar transistors each with accompanying reverse biased diodes in each module.

3. The method of claim 1 comprising implementing three limbs whereby generating electrical power signals compatible with conventional three phase power systems is provided.

4. The method of claim 1 comprising implementing two limbs whereby generating electrical power signals compatible with conventional single phase power systems is provided.

5. The method of claim 1 wherein each module has an operation performance that is substantially the same as two full bridge modules connected in series but fewer switching losses.

6. The method of claim 1 wherein one or more limbs each comprising two legs in series include a series inductor connected in each leg.

7. A method for delivering high voltage alternating current power as part of an
electrical power distribution network comprising:
implementing a plurality of series connected modules, wherein each module converts a high voltage DC voltage and current through use of a three step ladder across a first and second terminal of the module in response to selectively applied control signals that control six high power semiconductor switching elements in each module; and
in each of the series connected modules, applying the control signals over time to establish at least one of the following three states: a first state wherein direct current flows through three high power semiconductor switching elements and two capacitors in response to which a first voltage level is established across the terminals of the module, a second state wherein direct current flows through two high power semiconductor switching elements, a capacitor, and a reverse biased diode in response to which a second voltage level is established across the terminals of the module, and third state wherein direct current flows through two high power semiconductor switching elements and a reverse biased diode and in response to which the third voltage level is established across the terminals of the module.

8. The method of claim 6 wherein the high power semiconductor switching elements are insulated bipolar gate transistors accompanied by a reverse biased diode.

9. The method of claim 6 wherein the first voltage level is twice the second voltage level.

10. The method of claim 6 comprising implementing in the network a voltage sourced converter that uses the modules to convert DC to AC.

11. The method of claim 6 wherein the module consists essentially of six insulated gate bipolar transistor, six reverse biased diodes, and two capacitors.

12. A voltage sourced converter that converts high voltage DC to high voltage AC in
an electrical power distribution grid, comprising:
a module that converts high voltage DC through use of a three step high voltage ladder, wherein the module comprises
a first and second terminal;
three pairs of insulated high power insulated bipolar gate transistors, wherein the pairs are connected in series and the middle pair is positioned at a reverse polarity in relation to its series connected high power insulated bipolar gate transistors;
six reverse bias diode, each diode connected in parallel across one of the insulated bipolar gate transistors;
two capacitors that are connected in parallel, wherein a first capacitor is connected between the first and second pairs of high power insulated bipolar gate transistors and a second capacitor is connected between the second and third pairs of high power insulated bipolar gate transistors.

13. The voltage sourced converter of claim 12 wherein each capacitor a first terminal connected in between two of the high power semiconductor insulated bipolar gate transistors and a second terminal connected in between another two of the high power semiconductor insulated bipolar gate transistors.

14. The voltage sourced converter of claim 12 wherein each high power insulated bipolar gate transistor is configured to receive a control signal that determines a voltage state of the module.

15. The voltage sourced converter of claim 12 wherein the converter comprises one, two or three limbs with each limb comprising two legs in series and each limb or leg comprises a set of series connected modules which in operation convert DC to AC.

16. The voltage sourced converter of claim 15 wherein each leg comprises at least 1 module.

17. A high voltage power distribution grid comprising:
a plurality of voltage sourced converters that distribute high voltage DC or high voltage AC to AC or DC components of the network, wherein one or more of the voltage sourced converters comprises means for converting a high voltage DC through use of a three step voltage ladder,

18. A method for transforming electric power from high voltage AC voltage and AC current to high voltage DC voltage and DC current and from high voltage DC voltage and DC current to high voltage AC voltage and AC current which comprises passing the power through voltage sourced converters (VSCs) whose legs are comprised all or in part with 3 step ladder bridge modules connected in series.

19. The method of claim 18 which further comprises providing each leg of a VSC as a series of modules, which may include one or more 3 step ladder bridge modules.

20. The method of claim 18 which further comprises providing each leg of a VSC as a series connection of modules, which may include one or more modules of other types of electronic switches along with the series connection of one or more 3 step ladder bridge modules.

21. The method of claim 18 which further comprises providing each leg of a VSC with one or more 3 step ladder bridge modules that have a series inductor connected into the leg.

22. The method of claim 18 which further comprises providing a VSC with one or more 3 step ladder bridge modules in each leg that can be controlled with multilevel operation with or without pulse width modulation.

23. The method of claim 18 in which operation of a single 3 step ladder bridge may have the same operational performance as two full bridge modules connected in series.

24. The method of claim 23 in which a VSC containing 3 step ladder bridge modules in each leg may operate similarly to a VSC containing full converter bridge modules in each leg that are equivalent in voltage and current rating and are similarly controlled.

25. The method of claim 24 in which the 3 step ladder bridge modules will have fewer switching losses than the full converter bridge modules that are equivalent in voltage and current rating and are similarly controlled.
